(19) United States
(12) Patent Application Publication
(10) Pub. No.: US 2009/0097260 A1
(43) Pub. Date: Apr. 16, 2009

(54) STEEL GOBO WITH NON-REFLECTIVE HEAT RESISTANT COATING

(76) Inventor: Ivo Dielen, Antewerpen (BE)

Correspondence Address: OSTROLENK FABER GERB & SOFFEN, 1180 AVENUE OF THE AMERICAS, NEW YORK, NY, 100368403, US

(21) Appl. No.: 12/206,543

(22) Filed: Sep. 8, 2008

Related U.S. Application Data
(60) Provisional application No. 60/970,715, filed on Sep. 7, 2007.

(51) Int. Cl. F21S 10/06

(52) U.S. Cl. 362/317

(57) ABSTRACT

An optical device, or gobo, for use in a projector in accordance with the present application includes at least one surface that is has a layer of substantially non-reflective, heat resistant material formed on at least one surface thereof to prevent pattern distortion. The material preferably has a higher heat resistance than paint.

### BACKGROUND

1. Field of the Disclosure

The present application relates to an improved gobo for use in projecting a desired pattern of light. More specifically, the present application relates to a gobo including at least one surface that is coated with a substantially non-reflective, heat resistant material.

2. Related Art

Gobos are thin, typically circular plates that have patterns cut into them to allow for the projection of the light patterns on a surface. Gobos are commonly referred to as templates or patterns as well. Gobos control light by blocking or diffusing the light before it reaches a lens of a projector, for example. That is, the gobo is preferably positioned between a light source and the lens. The projector is often referred to as a lantern, and thus, these terms will be used interchangeably herein.

Since the light from the light source is shaped by the pattern of the gobo before the light reaches the lens, the projected pattern will retain any hard edges in the pattern cut into the gobo provided that the projection distance is not too far. As a result, the patterns that are provided by the gobo tend to be very sharp.

Gobos can be made of a variety of materials including stainless steel and glass. Stainless steel gobos are popular since they provide good durability and are relatively easy to work with, and thus, allow for the formation of somewhat intricate patterns.

Stainless steel gobos, however, do have limitations. One problem that is common in stainless steel gobos is pattern distortion. The lenses that are commonly used in projectors, or lanterns, that accommodate gobos are typically relatively inexpensive, and thus, do not include an anti-reflective layer on the inside surface of the lens. As a result, a substantial portion of the light that is to be projected out in the desired pattern is instead reflected back in toward the gobo. Since stainless steel gobos are shiny and rather reflective, thus light is then re-reflected back toward the lens. This re-reflected light, however, is no longer shaped by the pattern of the gobo, since it does not pass through the gobo again. As a result, the projected light pattern will be distorted. Specifically, the re-reflected light commonly results in a halo effect on the projected light pattern, which is undesirable.

One solution to this problem is to paint at least one surface of the gobo black in order to deter the re-reflection of light. However, the lanterns that are used in the projectors that accommodate gobos are relatively high power and thus generate a substantial amount of heat. As a result, if the gobo is painted, the heat will blister and burn the paint. Thus, this is not a very effective solution to the problem of pattern distortion.

Accordingly, it would be desirable to provide a steel gobo that avoids these problems.

### SUMMARY

It is an object of the present invention to provide a steel gobo including at least one surface that is covered with a substantially non-reflective, heat resistant layer of material to prevent re-reflection of light within the projector.

An optical device for use in a projector with a light source in accordance with an embodiment of the present application includes a substrate made of a reflective material with a pattern formed in the substrate such that light from the light source passes through the substrate in accordance with the pattern, and a layer of a substantially non-reflective and heat resistant material formed on a first side of the substrate, positioned opposite the light source.

An optical device for use in a projector with a light source in accordance with an embodiment of the present application includes a substrate made of steel with a pattern formed in the substrate such that light from the light source passes through the substrate in accordance with the pattern, and a layer of substantially non-reflective and heat resistant material formed on a first side of the substrate, positioned opposite the light source.

An optical device for use in a projector with a light source in accordance with an embodiment of the present application includes a disk-shaped substrate made of stainless steel with a pattern formed in the substrate such that light from the light source passes through the substrate in accordance with the pattern and a layer of substantially non-reflective and heat resistant material formed on a first side of the substrate, positioned opposite the light source, wherein the non-reflective and heat resistant material is a metal oxide that is heat resistant up to a temperature of 350° C. and is a dark color such that it reflects little light.

Other features and advantages of the present invention will become apparent from the following description of the invention, which refers to the accompanying drawings.

### BRIEF DESCRIPTION OF THE DRAWING(S)

FIG. 1 is an illustration of a first side of an exemplary steel gobo in accordance with an embodiment of the present application.

FIG. 2 is an illustration of a second side of the exemplary steel gobo of FIG. 1 in accordance with an embodiment of the present application.

FIG. 3 is a side view of the exemplary steel gobo of FIGS. 1 and 2 in accordance with an embodiment of the present application.

### DETAILED DESCRIPTION OF THE EMBODIMENTS

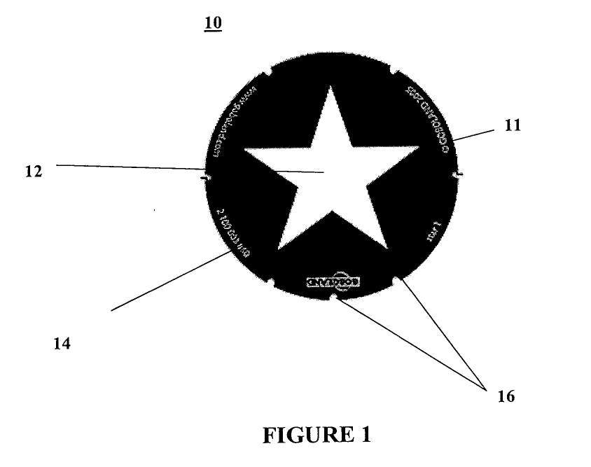

Referring to FIGS. 1-3, there is shown a stainless steel gobo 10 in accordance with an embodiment of the present application. A gobo is an optical device used to direct light. The gobo 10 is preferably made of a stainless steel substrate 11. As illustrated, at least one side, or surface of the substrate 11, which faces upward in FIG. 1, includes a layer 14 of a substantially non-reflective, heat resistant material. This layer 14 will preferably face the lens when the gobo 10 is mounted in a gobo projector, or lantern (not shown). As can be seen in FIG. 1, a pattern 12 is formed in the gobo 10 for directing the desired light pattern from the projector. More specifically, this pattern 12 is formed in the substrate 11 of the gobo 10. In a preferred embodiment, the pattern 12 is cut into the stainless steel substrate 11, but other methods of forming the pattern 12 may be used, if desired. The pattern 12 may be etched or laser cut into the substrate 11 of the gobo 10, for example. The gobo 10 is preferably structured to be positioned in the projector between a light source and the lens. The notches 16 around the periphery of the substrate 11 of the gobo 10 are preferably used to allow positioning of the gobo in a gobo holder (not shown) to allow for adjustment of the gobo. While FIG. 1 illustrates a gobo 10 with a specific pattern 12, the pattern may be any desired pattern. The substrate 11, and thus the gobo 10, are preferably disk-shaped, however, any desired shape may be used.

The gobo 10 may generally have a thickness of between 4-10 mils, however, in a preferred embodiment, it is set at a thickness of 6-8 mils. Naturally, any desirable thickness may be used depending on durability requirements and the intricacy of the pattern 12 that is formed in the substrate 11. That is, if durability is important, it may be desirable to provide a somewhat thicker gobo. If an intricate pattern is required, a somewhat thinner gobo may be desirable so that it can be cut, etched or otherwise altered in an easier manner. That is, a thinner gobo, and thus a thinner substrate, allows for finer etching.

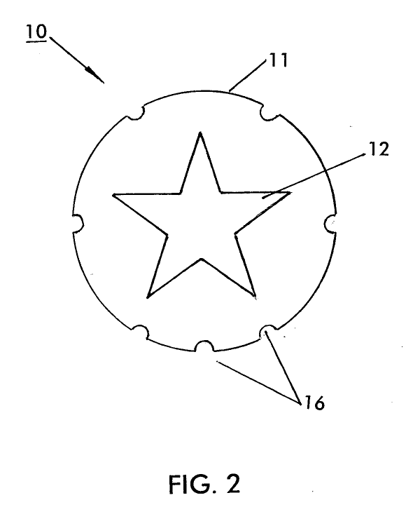

In the exemplary gobo 10 of FIG. 1, the layer 14 of non-reflective and heat resistant material on the illustrated surface is substantially black in color. While this is preferred, the material may be of any dark color so long as it is substantially non-reflective. In addition, the material should be heat resistant. Temperatures inside the gobo projector commonly reach 350° C. (approximately 650° F). Thus, the material should be able to resist this extreme heat without breaking down or separating from the gobo 10. The material may be a metal oxide, for example, chromium oxide, which is bonded to the underlying stainless steel substrate 11 of the gobo 10. Of course, the material may be any other suitable substantially non-reflective and heat resistant material as well. FIG. 2 illustrates the opposite surface of the gobo 10 of FIG. 1. As illustrated, this second side does not include a layer of non-reflective and heat resistant material, however, the material may be applied to both surfaces of the gobo 10, if desired.

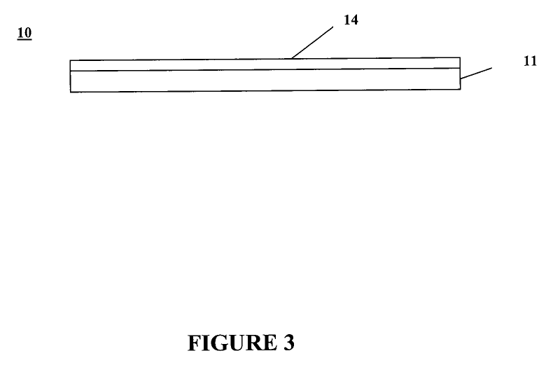

FIG. 3 illustrates a side view of the gobo 10 illustrated in FIG. 1 in which the substrate 11 is shown with the layer 14 of non-reflective and heat resistant material formed on a first surface of the substrate.

As is noted above, one non-limiting example of a suitable material for the layer 14 of material formed on the gobo 10 is chromium oxide. Of course, it would to be advantageous to use paint, since, as is noted above, paint does not have sufficient heat resistance to operate at the temperatures that the gobo 10 is subjected to.

The gobo 10 in accordance with the present application thus provides for a durable gobo such as one made of stainless steel, while eliminating the pattern distortion that results from the use of conventional stainless steel gobos. In addition, the layer 14 of substantially non-reflective and heat resistant material also provides a more pleasing and dynamic aesthetic appearance to the gobo as well. While the present application specifically describes forming a layer of non-reflective and heat resistant material on a surface of a stainless steel substrate of a gobo,

it need not be limited to this specific embodiment and could be used in conjunction with any gobo made of a reflective material, like aluminum, for example.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. An optical device for use in a projector with a light source comprising:
a substrate made of a reflective material with a pattern formed in the substrate such that light from the light source passes through the substrate in accordance with the pattern, and
a layer of a substantially non-reflective and heat resistant material formed on a first side of the substrate, positioned opposite the light source.

2. The optical device of claim 1, wherein the non-reflective and heat resistant material is heat resistant up to a temperature of 350° C.

3. The optical device of claim 2, wherein the non-reflective and heat resistant material is a dark color such that it reflects little light.

4. The optical device of claim 3, wherein the non-reflective and heat resistant material is black.

5. The optical device of claim 4, wherein the non-reflective and heat resistant material is a metal oxide.

6. The optical device of claim 5, wherein the non-reflective and heat resistant material is chromium oxide.

7. An optical device for use in a projector with a light source comprising:
a substrate made of steel with a pattern formed in the substrate such that light from the light source passes through the substrate in accordance with the pattern, and
a layer of substantially non-reflective and heat resistant material formed on a first side of the substrate, positioned opposite the light source.

8. The optical device of claim 7, wherein the non-reflective and heat resistant material is heat resistant up to a temperature of 350° C.

9. The optical device of claim 8, wherein the non-reflective and heat resistant material is a dark color such that it reflects little light.

10. The optical device of claim 9, wherein the non-reflective and heat resistant material is black.

11. The optical device of claim 10, wherein the non-reflective and heat resistant material is a metal oxide.

12. The optical device of claim 11, wherein the non-reflective and heat resistant material is chromium oxide.

13. An optical device for use in a projector with a light source comprising:
a disk-shaped substrate made of stainless steel with a pattern formed in the substrate such that light from the light source passes through the substrate in accordance with the pattern; and
a layer of substantially non-reflective and heat resistant material is formed on a first side of the substrate, positioned opposite the light source, wherein
the non-reflective and heat resistant material is a metal oxide that is heat resistant up to a temperature of 350° C. and is a dark color such that it reflects little light.

14. The optical device of claim 13, wherein the non-reflective and heat resistant material is a chromium oxide.
